(19) United States
(12) Patent Application Publication
(10) Pub. No.: US 2025/0192699 A1
(43) Pub. Date: Jun. 12, 2025

(54) ELECTRIC DRIVE SYSTEM

(71) Applicant: Rolls-Royce Deutschland Ltd & Co KG, Blankenfelde-Mahlow (DE)

(72) Inventors: Markus Sons, Nürnberg (DE); Jens Weidauer, Fürth (DE); Philipp Schildt, Strullendorf (DE)

(21) Appl. No.: 18/292,692

(22) PCT Filed: Jul. 12, 2022
(86) PCT No.: PCT/EP2022/069492

§ 371 Date: Feb. 3, 2025

(30) Foreign Application Priority Data
Jul. 27, 2021 (DE) 10 2021 208 075.8

(51) Int. Cl. H02P 5/74; B60L 3/00; B60L 58/21; B64D 27/34; B64D 27/357; B64D 31/16; H02P 101/30

(52) U.S. Cl. CPC H02P 5/74; B60L 3/0092; B60L 58/21; B64D 27/34; B64D 27/357; B64D 31/16; B60L 2200/10; B60L 2210/40; B60L 2220/42; B60L 2220/50; H02P 2101/30

(57) ABSTRACT

An electric drive system (1A-1D) comprises an electric motor (10; 10A, 10B) having a rotor (100) and a plurality of lanes (101A-101D) which are electrically isolated from one another and to which electric current can be applied independently of one another in order to drive the rotor (100); a respective supply unit (11) for each of the lanes (101A-101D); and a control system (12) which is designed to simultaneously operate at least one of the lanes (101A-101D) in a motor mode in which electric current is applied to the lane (101A-101D) via the corresponding supply unit (11) in order to convert electrical energy into kinetic energy of the rotor (100) and operate at least one of the lanes (101A-101D) in a generator mode in which electric current is provided by means of the lane (101A-101D) via the corresponding supply unit (11).

This application is the National Stage of International Application No. PCT/EP2022/069492, filed Jul. 12, 2022, which claims the benefit of German Patent Application No. DE 10 2021 208 075.8, filed Jul. 27, 2021. The entire contents of these documents are hereby incorporated herein by reference.

### BACKGROUND

The present disclosure relates to an electric drive system, a vehicle including such an electric drive system, and a method for operating an electric drive system.

Electric drive systems are becoming increasingly important, and more and more vehicle types are being equipped with electric drive systems (e.g., bicycles, cars, and airplanes). The respective electric drive systems convert electrical energy into kinetic energy for the vehicle. In the example of airplanes, the electric motor drives a propeller, for example. The electrical energy is carried by a battery, provided by an internal combustion engine with a generator, or generated in another way (e.g., by solar cells).

In electric drive systems in general, and in aircraft, in particular, a particularly high level of reliability is regularly sought, which is achieved by redundant assemblies, among other things. This makes it possible to provide that a single fault does not lead to a failure of the entire electric drive system by electrically and/or mechanically isolating the component or assembly affected by the fault from the rest of the electric drive system, while the rest of the electric drive system remains functional.

In practice, electric motors with a number of electrically insulated lanes are used for this purpose. Such an electric motor may also be referred to as a multi-lane electric motor. The electric motor therefore includes a number of (e.g., several) sub-motors, wire windings of which are electrically isolated from each other. All sub-motors of the electric motor drive the same rotor. If, for example, a short circuit occurs in the wire winding of one of the lanes, this may be electrically disconnected from a supply of drive energy while the remaining lanes continue to generate feed.

However, such multi-lane concepts often also entail an increased complexity of the corresponding electric drive system.

### SUMMARY AND DESCRIPTION

The present embodiments generally relate to analyzing input data of a respective device and/or controlling the respective device using a trained function.

The present embodiments may obviate one or more of the drawbacks or limitations in the related art. For example, high performance of an electric drive system with the simplest design may be provided.

According to one aspect, an electric drive system is provided. The electric drive system includes at least one electric motor having a rotor and a plurality of lanes that are electrically separate from one another and to which electric current may be applied independently of one another in order to cause the rotor to rotate relative to a stator. The electric drive system includes a supply unit for each of the lanes, and a control system that is set up (e.g., simultaneously) to operate at least one of the lanes in a motor mode, in which this lane is supplied with electrical current via the corresponding supply unit in order to convert electrical energy into kinetic energy of the rotor. The control system is also set up to operate at least one other of the lanes in a generator mode, in which electrical current is provided by this lane via the corresponding supply unit in order to convert kinetic energy of the rotor into electrical energy.

In this way, the multi-lane concept of the electric motor is used to exchange electrical energy between the lanes that are electrically isolated from each other (e.g., and any energy sources connected to the lanes that are also electrically isolated from each other). This enables a significant improvement in performance with increased reliability and, thanks to the dual use of the multi-lane electric motor, a simple design and low weight. This also enables a wide range of applications, which are described in detail below. A lane may also be described as a current path arrangement, for example. In the case of a three-phase alternating current, for example, each lane includes electrical conductors for all three phases. These conductors are electrically insulated from the conductors of the other lanes of the electric motor.

For example, the rotor is coupled to a turbomachine, such as a propeller, a fan, or a compressor (e.g., of an aircraft). The above-described advantages are particularly applicable to aircraft.

In one embodiment, the turbomachine has rotor blades with adjustable angles of attack. The control system may be set up to adjust the angle of attack of the rotor blades during simultaneous motor and generator operation such that the turbomachine does not generate propulsion. In this way, energy may be transferred between lanes when the aircraft is stationary, for example.

For example, each of the lanes includes or consists of an electrical winding system. The electrical winding system includes, for example, at least one wire winding. The wire winding(s) is/are formed, for example, (e.g., in each case) from a wire wound a number of times (e.g., around a tooth).

Each of the supply units includes an inverter, for example, and/or may be operated as an inverter. A direct current applied to the respective supply unit may therefore be converted into an alternating current for the electric motor. For example, the supply units may each be configured to convert a direct current into a three-phase alternating current and provide this to the corresponding lane. Each lane is therefore configured, for example, to be operated with a three-phase alternating current in order to set the rotor in rotation.

Further, at least one (e.g., all) of the supply units may include a rectifier and/or may be operated as a rectifier. Thus, the supply unit may be supplied with an alternating current of the respective lane in order to generate a direct current from the alternating current, which may, for example, be provided to an energy store in order to store electrical energy. The supply unit(s) is/are each configured, for example, to convert a three-phase alternating current from the corresponding lane into a direct current. The electric drive system thus makes it possible to transfer energy via the electric motor between DC lanes that are electrically isolated from each other (and independent of each other) without the need for additional components such as DC/DC converters or additional switches. One or each of the supply units may be operated both as an inverter and as a rectifier. For example, the control system optionally controls the supply unit(s) such that the supply unit(s) act either as an inverter or as a rectifier. The inverter and the rectifier in the supply unit (or supply units) are realized, for example, with the same hardware (e.g. with the same switches, transistors, or the like).

Optionally, the electric drive system also includes a generator that is electrically operatively connected to at least one of the lanes. The generator may be mechanically coupled to an internal combustion engine. Such a generator may be used, for example, to extend the range. The design of the electric drive system makes it possible, for example, to connect only some of the lanes to the generator, where the energy provided by the generator may be transferred to the other lanes via simultaneous motor and generator operation. This provides that some cable connections may be dispensed with, resulting in reduced weight and less cabling.

The generator may include a number of electrically separate lanes in which an electrical voltage is induced by the rotation of a rotor of the generator. Each lane of the generator is electrically connected to exactly one lane of the electric motor, for example. This enables a particularly high level of reliability.

Optionally, the electric drive system includes a further, second electric motor, also with a rotor and a number of electrically separate lanes that may be supplied with electric current independently of each other in order to drive the rotor of the other electric motor. This provides that sufficient thrust may also be generated for larger vehicles.

In one embodiment, at least one lane of the electric motor is operatively connected electrically to at least one lane of the generator, while at least one lane of the other electric motor is operatively connected electrically to at least one other lane of the generator. In this way, both electric motors may be supplied with power by the generator.

The electric drive system also includes, for example, an energy store electrically connected to at least one of the lanes. This provides, for example, that fossil fuels may be partially or completely dispensed with.

Optionally, the electric drive system includes a number of energy stores, each electrically connected to at least (or exactly) one of the lanes. It may be provided that electrical energy may be transmitted from one of the energy stores via a lane operated in motor mode and another lane operated in generator mode to another energy store.

According to an aspect, a vehicle (e.g., an aircraft, such as an airplane, a rotorcraft or an unmanned aerial vehicle, a land vehicle, such as a bus or a truck, or a watercraft) is provided. The vehicle includes the electric drive system according to any embodiment described herein (e.g., for driving a thrust-generating device, such as a propeller). The advantages of the electric drive system described herein apply especially to a vehicle (e.g., an aircraft).

In the vehicle, at least one energy store electrically connected to at least one of the lanes may be replaceably mounted on the vehicle. For this purpose, the vehicle includes a corresponding plug connector, for example. Alternatively or additionally, at least one energy store electrically connected to at least one of the lanes may be permanently mounted on the vehicle. For example, the permanently mounted energy stores serve as a reserve, and the replaceable energy store serves as the main energy source. In an operating mode that is not fully utilized (e.g., gliding, descending, taxiing, etc.), in the case of an aircraft, energy may be exchanged between the energy stores via the electric motor. This allows, for example, the permanently installed energy store to be fully charged with residual energy from the replaceable energy store before the replaceable energy store is replaced.

The vehicle may be configured as an aircraft with a fuselage and wings, where, for example, at least one energy store electrically connected to at least one of the lanes is mounted on or in the fuselage (e.g., replaceably), and at least one energy store electrically connected to at least one of the lanes is mounted on or in one of the wings (e.g., fixedly).

According to one aspect, a method for operating an electric drive system (e.g., a drive system according to any embodiment described herein) is provided. The electric drive system includes at least one electric motor having a rotor, a plurality of lanes that are electrically separate from one another and to which electric current may be applied independently of one another in order to drive the rotor, and in each case a supply unit for each lane of the at least one electric motor. It is provided that at least one of the lanes is operated in a motor mode, in which the lane is supplied with electric current via the corresponding supply unit in order to convert electric energy into kinetic energy of the rotor, and, at the same time, at least one other of the lanes is operated in a generator mode, in which electric current is provided by the lane via the corresponding supply unit in order to convert kinetic energy of the rotor into electric energy.

### BRIEF DESCRIPTION OF THE DRAWINGS

FIG. 1 shows a schematic sectional illustration of an electric drive system with a permanently excited, three-phase electric motor in the form of an internal rotor;

FIG. 2 shows a schematic block diagram of an electric drive system with two electric motors, a separate generator, and a number of energy stores;

FIG. 3 shows a schematic block diagram of an electric drive system with two electric motors and a number of energy stores, some of which are combined in an electric energy storage system;

FIG. 4 shows a schematic block diagram of an electric drive system with two electric motors connected to a common energy storage system; and

FIG. 5 shows a schematic representation of an aircraft in the form of an airplane.

### DETAILED DESCRIPTION

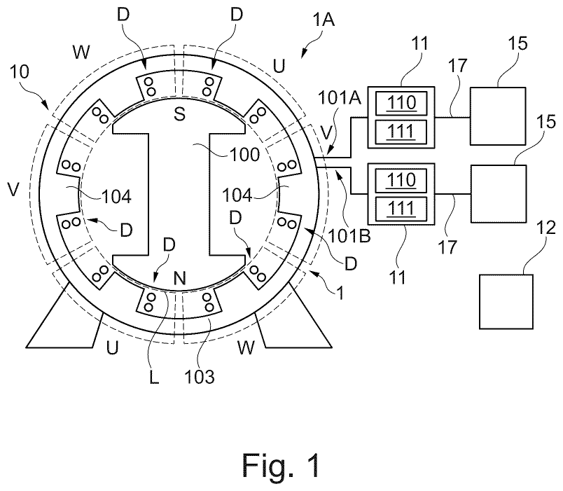

FIG. 1 shows a schematic sectional illustration of an electric drive system 1A with an electric motor 10 in the form of a permanently excited synchronous machine. FIG. 1 shows that the electric motor 10 is in the form of an internal rotor. The electric motor 10 includes an assembly in the form of a stator 103 that has an opening (e.g., a through-opening that is not denoted) in which a further assembly in the form of a rotor 100 is arranged in a rotatably mounted manner.

The stator 103 includes a body in the form of a laminated core, on which teeth (e.g., stator teeth) are anchored. The stator teeth are aligned with an air gap L between the body of the stator 103 and the rotor 100. The stator teeth protrude radially from the body (e.g., in the present case, radially inward).

The electric motor 10 further includes a number of (e.g., two) lanes 101A, 101B that are electrically insulated from one another and may be supplied with electric current independently of one another in order to drive the rotor 100. Each lane 101A, 101B forms a partial motor or sub-motor that may be operated independently of the others.

Each of the lanes 101A, 101B has a winding system for this purpose, which includes a number of wire windings D. The wire windings D are each wound around the stator teeth. The winding systems are presently configured for three-phase operation (e.g., connected to a three-phase AC voltage with phases U, V, W). In the intended operation of the electric drive system 1A, the winding systems may be supplied with the AC voltage accordingly. The winding systems of all lanes 101A, 101B are fixed to the same stator 103.

The lanes 101A, 101B are galvanically isolated from each other. The rotor 100 may be set in rotation relative to the stator 103 by applying the AC voltage to only one of the lanes 101A, 101B, as well as by applying the AC voltage to all lanes 101A, 101B.

The rotor 100 is configured here merely by way of example as a salient pole rotor that includes permanent magnets for providing the magnetic flux. In the present embodiment, it is provided that the rotor 100 has exactly one magnetic north pole N and one magnetic south pole S. In alternative configurations, there may also be provision for more magnetic poles in alternation in the circumferential direction transverse to an axis of rotation of the rotor 100 (e.g., relative to the stator 103).

The rotor 100 is rotatably mounted. As a result of the three-phase AC voltage, the phases U, V, W thereof each being phase-shifted by 120°, a magnetic rotating field is generated by one or both lanes 101A, 101B in the intended operation and interacts with the permanently excited magnetic field provided by the rotor 100, so that a corresponding rotational movement of the rotor 100 in relation to the stator 103 may be brought about during motor operation of the lane(s) 101A, 101B. In the present case, it is intended that the electric motor 10 serves as a drive motor for a propeller of an aircraft, as will be explained in more detail below. The portions of the winding systems that are assigned to the respective phases U, V, W are schematically illustrated in FIG. 1.

Further, the lanes 101A, 101B may be operated in a generator mode, in which electrical current is provided by the respective lane 101A, 101B in order to convert mechanical energy of the rotor 100 into electrical energy.

The two lanes 101A, 101B of the electric motor 10 are each connected to one of two independent three-phase supply units 11.

The supply units 11 may be switched between inverter mode and rectifier mode (or at least this applies to one of the supply units 11). In inverter mode, the respective supply unit 11 generates the AC voltage for the corresponding lane 101A, 101B from a DC voltage. In rectifier mode, the respective supply unit 11 generates a DC voltage from an AC voltage generated in the corresponding lane 101A, 101B by rotating the rotor 100. In inverter mode, in one possible embodiment, (e.g., at least in part) the same electrical and/or electronic components of the respective supply unit 11 are active as in rectifier mode.

A control system 12 of the electric drive system 1A is operatively connected to the supply units 11 and selectively switches the supply units 11 to inverter mode or rectifier mode. The control system 12 is hereby set up to operate one of the lanes 101A, 101B in motor mode by applying alternating electrical current to the lane 101A, 101B via the corresponding supply unit 11 in order to convert electrical energy into kinetic energy of the rotor 100, and (e.g., simultaneously with this) to operate at least one other of the lanes 101A, 101B in generator mode by supplying alternating electric current from the lane 101A, 101B to the corresponding supply unit 11 and direct current through the corresponding supply unit 11 in order to convert kinetic energy of the rotor 100 into electric energy.

The supply units 11 provide the electric AC voltage with the three phases U, V, W. The supply units 11 each obtain the electrical energy required for the intended operation from an energy source connected to one of the two supply units 11 via an electrical connection 17 (e.g., in each case, in the form of an energy store 15). The individual electrical connections 17 may also be referred to as direct voltage lanes or DC lanes (or in each case as a DC bus). The energy stores 15 (e.g., the energy sources) are electrically isolated from one another and may be operated independently of one another. In the present embodiment, each of the energy sources is a DC voltage source that provides electrical energy (e.g., from a rechargeable battery). Alternatively or additionally, fuel cells and/or the like may be provided.

To generate the AC voltage from the DC voltage, each of the supply units 11 includes an inverter 110. The inverters 110 each have, for example, a full-bridge circuit to provide the phases U, V, W. For example, the inverters 110 may each have at least one series circuit including two electronic switching elements (e.g., transistors), which is connected to the respective DC voltage of the energy source. The electronic switching elements are operated by a control unit of the respective inverter 110 in a clock mode that provides clock patterns in the form of a PWM signal, for example.

Further, each of the supply units 11 includes a rectifier 111. Using the rectifier 111, the respective supply unit 11 may rectify an alternating current induced by a rotation of the rotor 100 in the connected lane 101A, 101B and may provide the rectified alternating current as direct current to the corresponding energy store 15.

In inverter mode, the inverter 110 is activated and the rectifier 111 is deactivated. In rectifier mode, the inverter is deactivated and the rectifier is activated.

If one of the lanes 101A, 101B is simultaneously operated in motor mode and the other in generator mode, it is thus possible to transfer energy between the DC lanes, which are electrically isolated from each other, and, for example, the energy stores 15. If the pitch of rotor blades mounted on the rotor 100 and/or rotatable thereby is set, for example, such that no propulsion is generated, this may even take place when the aircraft is stationary, for example.

The control system 12 may include a central control unit and/or a number of distributed control units (e.g., one control unit in each of the supply units 11).

For the sake of simplicity, the supply units 11 are counted, for example, as part of the electric drive system 1A, but may also be regarded as part of the lanes 101A, 101B connected to the supply units 11.

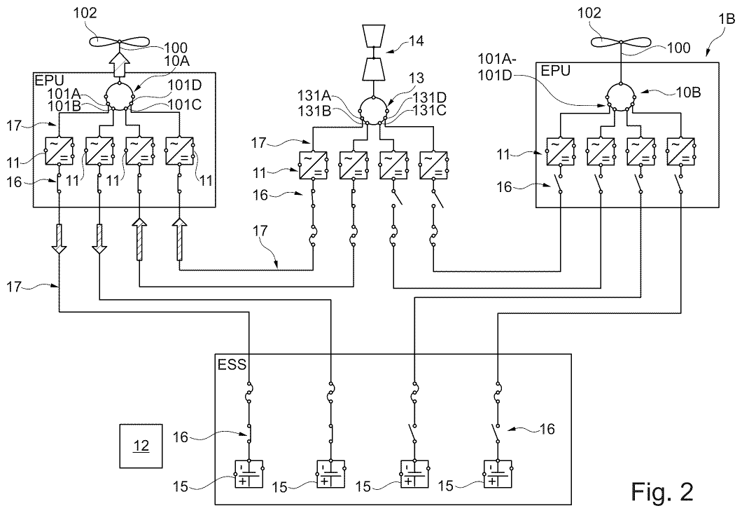

FIG. 2 shows an electric drive system 1B for a vehicle (e.g., an aircraft) with two electric motors 10A, 10B. Each of the electric motors 10A, 10B drives a turbomachine 102 in the form of a propeller via a rotor 100.

Each of the electric motors 10A, 10B includes a number of (e.g., four) separate lanes 101A-101D. The respective propeller may be driven by each of the lanes 101A-101D (e.g., the respective propeller is set in rotation when at least one of the lanes 101A-101D is supplied with power). The lanes of each electric motor 10A, 10B are electrically insulated from each other.

Each of the lanes 101A-101D of the electric motors 10A, 10B is connected to a supply unit 11 via a corresponding electrical connection 17. The supply units 11 are configured, for example, as explained in conjunction with FIG. 1. The supply units 11 allow at least one of the lanes 101A-101D to be operated simultaneously in a motor mode, in which electrical current is applied to the lane 101A-101D via the corresponding supply unit 11 in order to convert electrical energy into kinetic energy of the rotor 100, and at least one of the lanes 101A-101D is to be operated in a generator mode, in which electrical current is provided by the lane 101A-101D via the corresponding supply unit 11 in order to convert kinetic energy of the rotor 100 into electrical energy.

Each of the electric motors 10A, 10B, together with the supply units 11 connected to the electric motors 10A, 10B, forms an electric drive unit EPU (e.g., in this case, for the respective turbomachine 102).

The electric drive system 1B also includes an internal combustion engine 14 (e.g., in the form of an auxiliary power unit (APU) with a compressor and a turbine). The internal combustion engine 14 drives a generator 13. The generator 13 includes a number of (e.g., four) lanes 131A-131D. Each of the lanes 131A-131D is electrically connected to (e.g., only) exactly one respective supply unit 11 via a corresponding electrical connection 17 and is in electrical operative connection via this supply unit 11 with (e.g., only) exactly one lane 101A-101D of one or the other electric motor 10A, 10B. Instead of the internal combustion engine 14 with the generator 13, other devices for generating electrical energy may also be provided (e.g., one or more fuel cells).

Further, the electric drive system 1B includes an electrical energy storage system ESS. The electrical energy storage system ESS includes a number of (e.g., several) energy stores 15. The individual energy stores 15 of the electrical energy storage system ESS are electrically isolated from one another. In the present case, the energy stores 15 are each in the form of a rechargeable battery.

Each of the energy stores 15 is connected to (e.g., only) exactly one supply unit 11 via an electrical connection 17 and is in electrical active connection with (e.g., only) exactly one lane 101A-101D of one or the other electric motor 10A, 10B via this supply unit 11.

Specifically, a number of (e.g., exactly two) lanes 101A, 101B of each of the two electric motors 10A, 10B are in electrical operative connection (e.g., via the respective supply units 11) with, in each case, one of the number of (e.g., exactly four) energy stores 15. The remaining lanes 101C, 101D of each of the two electric motors 10A, 10B (e.g., also exactly two in each case) are in electrical operative connection (e.g., via the respective supply units 11) with, in each case, one of the number of (e.g., exactly four) lanes 131A-131D of the generator 13. More generally formulated, at least one of the lanes 101A, 101B of an electric motor 10A, 10B of the electric drive system 1B is in electrical operative connection with the generator 13, and at least one other of the lanes 101C, 101D of the electric motor 10A, 10B is in electrical operative connection with the electric energy storage system ESS. This allows restrictions in the operation of the generator 13 due to changing battery voltages to be avoided.

At least the lanes 101A, 101B that are in electrical operative connection with one of the energy stores 15 may be operated either in motor mode or in generator mode. For this purpose, for example, the respective supply units 11 may be switched over (e.g., between inverter operation and rectifier operation, such as described above).

Optional switches 16 in the electrical connections 17 may be opened and closed to disconnect one of the connected components (e.g., in the event of a component fault or when not in use).

FIG. 2 uses arrows to illustrate an example usage scenario in which only one of the two propellers is set in rotation, optionally with an angle of attack at which no thrust is generated by the propeller. The internal combustion engine 14 drives the generator 13 so that voltages are induced at its lanes 131A-131D. This causes voltages to be applied via the supply units 11 and the closed switches 16 in the lanes 101C, 101D of the one electric motor 10A, which result in a current flow that generates an alternating magnetic field. The alternating magnetic field causes the rotor 100 to rotate. This induces voltages in the remaining two lanes 101A, 101B of the electric motor 10A, which cause a charging current for the respective energy stores 15 via the corresponding supply units 11. In this way, the generator 13 may charge the energy stores 15 via the electric motor 10A despite galvanic isolation from the energy stores 15.

Optionally, the other electric motor 10B may be operated analogously by the control system 12 controlling the switches 16 and the supply units 11 accordingly.

The control system 12 determines the positions of the switches 16 and the setting of the supply units 11 in generator mode or motor mode.

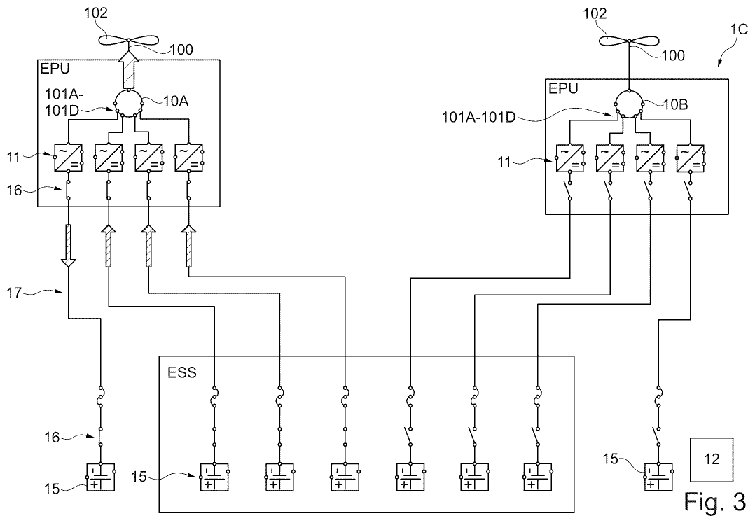

FIG. 3 shows an electric drive system 1C for a vehicle (e.g., an aircraft) with two electric motors 10A, 10B that are constructed as shown in FIG. 2, but connected differently.

The electric drive system 1C as shown in FIG. 3 does not include an internal combustion engine with a generator. All lanes 101A-101D of the electric motors 10A, 10B are (e.g., exclusively) connected to energy stores 15 via the respective supply units 11. In the present case, the energy stores 15 are each in the form of a rechargeable battery.

Exactly one energy store 15 is provided for each lane 101A-101D of each of the electric motors 10A, 10B (e.g., eight energy stores 15 for a total of eight lanes 101A-101D).

In the example shown, some of the energy stores 15 are combined to form an electrical energy storage system ESS. This electrical energy storage system ESS is installed on the vehicle (e.g., via corresponding plug connectors) in a non-destructive, removable, and replaceable manner. The electrical energy storage system ESS serves as the primary energy source. If the electrical energy storage system ESS has a low charge level, the electrical energy storage system ESS may be quickly replaced with a fully charged electrical energy storage system ESS and therefore does not have to be charged on the vehicle, which would typically be much more time-consuming. The energy stores 15 of the electrical energy storage system ESS are mounted in a common housing or on a common support frame, for example.

Further (e.g., two) energy stores 15 are arranged separately from the electrical energy storage system ESS and are, for example, permanently attached to the vehicle. These energy stores 15 are used, for example, to maintain an energy reserve and/or to provide additional energy at maximum power consumption (e.g., when the vehicle, which is configured as an aircraft, takes off). For example, the energy transmission via the electric motors 10A, 10B also makes it possible to provide such reserve energy stores 15 without the need for additional DC/DC converters or the like to connect the reserve energy stores 15.

As illustrated by the arrows, the separate energy stores 15 may be charged via the corresponding electric motor 10A, 10B by supplying energy from the electrical energy storage system ESS to the other (e.g., three) lanes 101B-101D. This may take place, for example, during gliding flight or on the tarmac (e.g., in the case of an automobile or bus, during a journey that is not fully loaded).

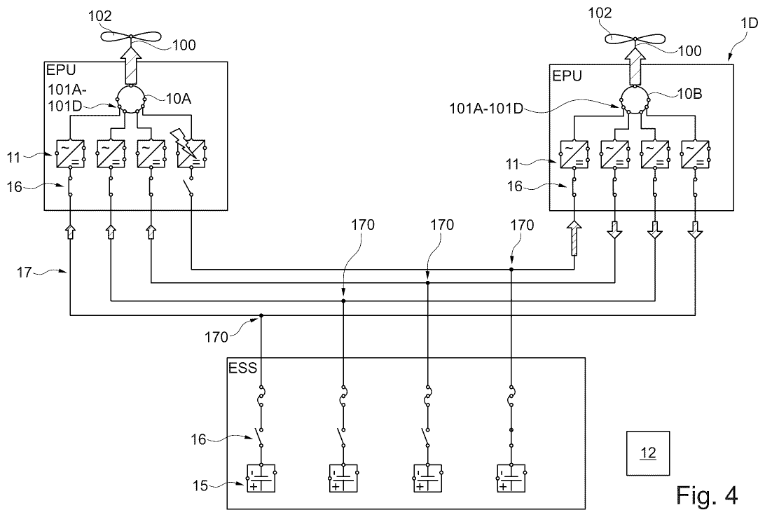

FIG. 4 shows an electric drive system 1D for a vehicle (e.g., an aircraft) with two electric motors 10A, 10B that are constructed as shown in FIGS. 2 and 3, but connected differently.

In this example, the electric drive system 1D as shown in FIG. 4 does not include an internal combustion engine or a separate generator. All lanes 101A-101D of the electric motors 10A, 10B are (e.g., exclusively) connected to energy stores 15 via the respective supply units 11. The energy stores 15 are again, by way of example, each in the form of a rechargeable battery.

For one lane 101A-101D of one electric motor 10A and one lane 101A-101D of the other electric motor 10B, exactly one common energy store 15 is provided (e.g., four energy stores 15 for a total of eight lanes 101A-101D). The electrical connection 17 from each of the energy stores 15 to the supply units 11 of the two associated lanes 101A-101D thus has a branch 170.

This circuit enables this lane 101A-101D to be switched off in the event of a fault in one of the lanes 101A-101D and the energy not called up by this lane 101A-101D to be distributed via the other electric motor 10A, 10B, such that both electric motors 10A, 10B generate the same thrust and/or all energy stores 15 are discharged equally.

In the example shown, a fault has occurred in the supply unit 11 of the fourth lane 101D of one electric motor 10A. The control system 12 has disconnected this supply unit 11 from the corresponding energy store 15 via the associated switch 16. The remaining lanes 101A-101C of the electric motor 10A continue to be operated. The lane 101A of the other electric motor 10B that is connected to the faulty supply unit 11 via the corresponding branch 170 now consumes only the energy of the associated energy store 15 due to the fault. Without a transfer of energy to the other lanes 101A-101D, this energy store 15 would therefore only be emptied half as quickly as the other energy stores 15, and unused energy would remain. This would also reduce the range.

The described configuration of the electric drive system 1D makes it possible to operate the remaining lane 101A of this energy store 15 with a higher current and/or to operate one or more of the other lanes 101B-101D of this electric motor 10B at least temporarily in generator mode. The energy fed in in this way may be made available to the remaining lanes 101A-101C of the electric motor 10A. Optionally, the remaining energy stores 15 are decoupled at least temporarily by opening the associated switches 16. Alternatively, the switches 16 of the energy stores 15 are closed, and, for example, the switches 16 of the remaining lanes 101A-101C of the electric motor 10A are opened. The remaining energy stores 15 may then be charged.

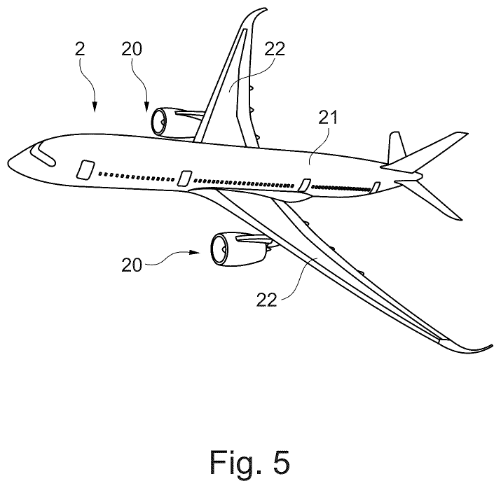

FIG. 5 shows a vehicle (e.g., an aircraft 2 in the form of an electrically driven airplane). The aircraft 2 includes a fuselage 21 with wings 22 attached thereto. An engine 20 is mounted on each of the wings 22. The aircraft 2 further includes one of the electric drive systems 1A-1D described herein (e.g., the electric drive system 1C as shown in FIG. 3). The electric energy storage system ESS is interchangeably arranged in the fuselage 21, while further energy stores 15 of the electric drive system 1C are permanently mounted in the wings. The engines 20 each include one of the electric motors 10A, 10B. The turbomachines 102 are each configured, for example, as a fan so that the electric motors 10A, 10B of the electric propulsion system 1C may generate thrust in order to drive the aircraft 2.

The invention is not limited to the embodiments described above, and various modifications and improvements may be made without departing from the concepts described here. Any of the features may be used separately or in combination with any other features, unless they are mutually exclusive, and the disclosure extends to and includes all combinations and subcombinations of one or more features that are described herein.

The elements and features recited in the appended claims may be combined in different ways to produce new claims that likewise fall within the scope of the present invention. Thus, whereas the dependent claims appended below depend from only a single independent or dependent claim, it is to be understood that these dependent claims may, alternatively, be made to depend in the alternative from any preceding or following claim, whether independent or dependent. Such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An electric drive system comprising:
an electric motor with a rotor and a plurality of lanes electrically separated from one another, the plurality of lanes being energizable independently of one another with electrical current in order to drive the rotor;
a supply unit for each lane of the plurality of lanes; and
a control system that is configured to simultaneously operate at least one first lane of the plurality of lanes in a motor mode, in which electrical current is applied to the at least one first lane via the corresponding supply unit, such that electrical energy is converted into kinetic energy of the rotor-, and to operate at least one second lane of the plurality of lanes in a generator mode, in which electrical current is provided by the at least one second lane via the corresponding supply unit.

2. The electric drive system of claim 1, wherein the rotor is coupled to a turbomachine.

3. The electric drive system of claim 2, wherein the turbomachine has rotor blades with angles of attack that are adjustable, and
wherein the control system is configured to be set up to adjust the angles of attack of the rotor blades during simultaneous operation of the motor mode and the generator mode, such that the turbomachine does not generate propulsion.

4. The electric drive system of claim 1, wherein each lane of the plurality of lanes comprises an electric winding system having at least one wire winding.

5. The electric drive system of claim 1, wherein each supply unit comprises an inverter, is operable as an inverter, or a combination thereof, and
wherein each of the supply units is configured to convert a direct current into a three-phase alternating current and provide the three-phase alternating current to the corresponding lane.

6. The electric drive system of claim 1, wherein one or each of the supply units comprises a rectifier, is operable as a rectifier, or a combination thereof, and wherein the one or each of the supply units is configured to convert a three-phase alternating current from the corresponding lane into a direct current.

7. The electric drive system of claim 1, further comprising a generator that is electrically operatively connected to at least one lane of the plurality of lanes and is mechanically coupled to an internal combustion engine.

8. The electric drive system of claim 7, wherein the generator comprises a plurality of lanes electrically separated from one another.

9. The electric drive system, of claim 8 further comprising a further electric motor , the further electric motor comprising a rotor and a plurality of lanes that are electrically separated from one another and are energizable independently of one another with electrical current in order to drive the rotor of the further electric motor.

10. The electric drive system of claim 9, wherein at least one lane of the plurality of lanes of the electric motor is electrically operatively connected to at least one lane of the generator, and at least one lane of the plurality of lanes of the further electric motor is electrically operatively connected to at least one further lane of the generator.

11. The electric drive system of claim 1, further comprising an energy store electrically connected to at least one lane of the plurality of lanes.

12. The electric drive system of claim 1, further comprising a plurality of energy stores, each energy store of the plurality of energy stores being electrically connected to at least one lane of the plurality of lanes,
wherein electrical energy is transferable from one energy store of the plurality of energy stores via a lane of the plurality of lanes operated in motor mode and a lane of the plurality of lanes operated in generator mode to another energy store of the plurality of energy stores.

13. A vehicle comprising:
an electric drive system comprising:
an electric motor with a rotor and a plurality of lanes electrically separated from one another, the plurality of lanes being energizable independently of one another with electrical current in order to drive the rotor;
a supply unit for each lane of the plurality of lanes; and
a control system that is configured to simultaneously operate at least one first lane of the plurality of lanes in a motor mode, in which electrical current is applied to the at least one first lane via the corresponding supply unit, such that electrical energy is converted into kinetic energy of the rotor, and to operate at least one second lane of the plurality of lanes in a generator mode, in which electrical current is provided by the at least one second lane via the corresponding supply unit.

14. The vehicle of claim 13, further comprising:
at least one first energy store electrically connected to at least one lane of the plurality of lanes, the at least one first energy store being replaceably mounted on the vehicle; and
at least one second energy store electrically connected to at least one lane of the plurality of lanes, the at least one second energy store being permanently mounted on the vehicle.

15. The vehicle of claim 13, wherein the vehicle is configured as an aircraft with a fuselage and wings, and
wherein the vehicle further comprises:
at least one first energy store electrically connected to at least one lane of the plurality of lanes, the at least one first energy store being mounted on or in the fuselage; and
at least one second energy store electrically connected to at least one lane of the plurality of lanes, the at least one second energy store being mounted on or in one of the wings.

16. A method for operating an electric drive system, comprising an electric motor with a rotor and a plurality of lanes that are electrically separated from one another and are energizable independently of one another with electrical current in order to drive the rotor, and one supply unit for each lane of the plurality of lanes of the electric motor, the method comprising:
simultaneously operating at least one lane of the plurality of lanes in a motor mode, in which the at least one lane is energized with electrical current via the respective supply unit, such that electrical energy is converted into kinetic energy of the rotor, and one or more lanes of the plurality of lanes are operated in a generator mode, in which electrical current is provided from the lane one or more lanes via the respective supply unit.

17. The electric drive system of claim 2, wherein the turbomachine is a propeller, a fan, or a compressor.

18. The vehicle of claim 13, wherein the vehicle is an aircraft.
